(19) United States
(12) Patent Application Publication
(10) Pub. No.: US 2015/0067724 A1
(43) Pub. Date: Mar. 5, 2015

(54) RECOMMENDING MEDIA ITEMS USING SOCIAL NETWORKS

(71) Applicant: NETFLIX, INC., Los Gatos, CA (US)

(72) Inventors: CAMERON JOHNSON, San Carlos, CA (US); NAVIN PRASAD, San Francisco, CA (US); JOHN MIDGLEY, San Jose, CA (US)

(73) Assignee: NETFLIX, INC., Los Gatos, CA (US)

(21) Appl. No.: 14/173,690

(22) Filed: Feb. 5, 2014

Related U.S. Application Data
(60) Provisional application No. 61/872,814, filed on Sep. 2, 2013.

(51) Int. Cl. H04N 21/466; H04N 21/488; H04N 21/482

(52) U.S. Cl. CPC H04N 21/4668; H04N 21/4826; H04N 21/4882
USPC 725/32

(57) ABSTRACT

Techniques are provided with which a subscriber to a media viewing service, which is configured for viewing media items such as TV shows or movies using streaming video delivery or other viewing techniques, may recommend one or more played or viewed media items to one or more friends in media viewing services or social networking systems that the subscriber uses. The subscriber may receive notifications when the friends view or play the recommended media items, and may contribute implicit feedback to a separate recommendation system regarding a recommended media item even when the subscriber has not explicitly rated the recommended media item. Subscribers also receive rapid indications, at the time that the subscribers are preparing to make recommendations of media items, about whether friends have already played or viewed the media items. In one embodiment, a recommendation may be communicated to a selected friend using a single operation of a pointing device.

### BENEFIT CLAIM

This application claims the benefit under 35 USC 119(e) of provisional application 61/872,814, filed Sep. 2, 2013, the entire contents of which are hereby incorporated by reference for all purposes as if fully set forth herein.

### FIELD OF THE DISCLOSURE

The present disclosure generally relates to data processing in the field of computer systems that provide media playing functions. The disclosure relates more specifically to techniques with which users of such systems may recommend a media item to another user.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Viewing media items such as movies, television episodes, and other audiovisual recordings is a popular pastime that is supported by computer-based systems such as the NETFLIX service. A user of such a system, after playing a media item that the user liked, may wish to recommend or suggest the media item to a friend, family member, or other user. However, in the past, automated techniques for providing such recommendations have been limited or have had significant drawbacks.

### SUMMARY

The appended claims may serve as a summary of the invention.

### BRIEF DESCRIPTION OF THE DRAWINGS

In the drawings:

FIG. 1 illustrates a data processing system with which an embodiment may be implemented.

FIG. 2 illustrates an example process flow that may be executed using one or more computing devices to implement an embodiment.

FIG. 3 illustrates in block diagram format an example graphical user interface that may be used in one embodiment.

FIG. 4 illustrates an example graphical user interface that may be used in one embodiment.

FIG. 5 illustrates a thumbnail image of a social networking friend with a message indicating that the friend has already played or viewed a media item.

FIG. 6 illustrates a thumbnail image of a social networking friend with an icon indicating that the friend is selected.

FIG. 7 illustrates a portion of an example graphical user interface that may be used in one embodiment showing multiple selected friends, an error message and a comment.

FIG. 8 and FIG. 9 illustrate portions of example graphical user interfaces that may be used in one embodiment showing an example recommend link.

FIG. 10A illustrates a portion of an example graphical user interface that may be used in one embodiment.

FIG. 10B illustrates a portion of an example graphical user interface that may be used in one embodiment showing multiple selected friends and a confirmation message.

FIG. 10C illustrates a portion of an example graphical user interface that may be used in one embodiment showing a selected friend, a confirmation message and a prompt for a next title.

FIG. 11 illustrates a portion of an example graphical user interface that may be used in one embodiment showing a notification icon and three (3) notification messages relating to recommendations and viewed recommendations.

FIG. 12 illustrates another example process flow that may be executed using one or more computing devices to implement an embodiment.

FIG. 13 illustrates a computer system with which an embodiment may be used.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. Overview

Techniques are provided with which a subscriber to a media viewing service, which is configured for viewing media items such as TV shows or movies using streaming video delivery or other viewing techniques, may recommend one or more played or viewed media items to one or more friends via the media viewing service or in a social networking system that the subscriber uses. Subscribers may receive notifications when the friends view or play the recommended media items and implicit feedback may be contributed to a separate recommendation system regarding a recommended media item even when the subscriber has not explicitly rated the recommended media item. Subscribers may also receive rapid indications, at the time that the subscribers are preparing to make recommendations of media items, about whether friends have already played or viewed the media items. In one embodiment, a recommendation may be communicated to a selected friend using a single operation of a pointing device.

Example embodiments are represented in the following numbered clauses:

1. A data processing method, comprising: using a computer, obtaining data identifying one or more friends in a social networking system; using the computer, determining an occurrence of an interaction with a particular media item in association with an account of a media viewing service associated with a recommending user; using the computer, based on the determination of the occurrence of the interaction with the particular media item in association with the account of the media viewing service associated with the recommending user, causing display of one or more images each respectively representing a friend among the one or more friends; using the computer, detecting user input indicating movement of a cursor over a first particular image among the one or more images; using the computer, in response to detecting the user input, automatically displaying, in association with the first particular image, a message indicating that the particular media item was previously viewed based on a determination that a first particular friend represented by the first particular image has previously viewed the particular media item.

2. The method of clause 3 wherein the interaction with the particular media item is a rating of the particular media item.

3. The method of clause 3 wherein the interaction with the particular media item is a play operation related to the media item.

4. The method of clause 1, comprising receiving selection data indicating a single operation of a user input device in association with a second particular image among the one or more images; in response to receiving the selection data, automatically communicating a recommendation message identifying the particular media item to an account associated with a second friend represented by the second particular image.

5. The method of clause 4 wherein the selection data indicates clicking or operating a pointing device while the cursor is over the second particular image.

6. The method of clause 4 wherein communicating the recommendation message comprises invoking a function of the social networking system that causes generating and providing a social message within a messaging facility of the social networking system that contains content of the recommendation message.

7. The method of clause 4 wherein communicating the recommendation message comprises causing display of a notification icon in a home page of the social networking system and, in response to receiving a selection of the notification icon, causing display of the recommendation message.

8. The method of clause 4 wherein communicating the recommendation message comprises causing, in association with a second account of the media viewing service that is associated with the second friend, display of a notification icon in an interface of the media viewing service and, in response to receiving a selection of the notification icon, causing display of the recommendation message.

9. The method of clause 1, comprising: receiving selection data indicating a selection of a second particular image among the one or more images; in response to receiving the selection data: automatically communicating a recommendation message identifying the particular media item to an account associated with a second friend represented by the second particular image; and automatically communicating to a recommendations system an item of implicit positive feedback for the particular media item, and causing use of the item of implicit positive feedback in a process of recommending other media items.

10. The clause of clause 4, comprising determining that a second account of the media viewing service that is associated with the second friend represented by the second particular image has played the particular media item, and in response, generating a notification message to the account of the media view service associated with the recommending user indicating that the second account played the particular media item.

11. The method of clause 1 wherein the play operation comprises completing playing the particular media item.

12. The method of clause 1 wherein the particular media item is a television episode.

13. A data processing method, comprising: using a computer, obtaining data identifying one or more friends in a social networking system; using the computer, determining an occurrence of a play operation related to a particular media item or a rating of the particular media item in association with an account of a media viewing service associated with a recommending user; using the computer, based on the determination of the occurrence of the play operation related to the particular media item or a rating of the particular media item in association with the account of the media viewing service associated with the recommending user, causing display of one or more images each respectively representing a friend among the one or more friends; using the computer, receiving selection data indicating a single operation of a user input device in association with a first particular image among the one or more images; using the computer, in response to the single operation, automatically communicating a recommendation message identifying the particular media item to an account that is associated with a particular friend represented by the first particular image.

14. The method of clause 13 wherein the selection data indicates clicking or operating a pointing device while a cursor is over the first particular image.

15. The method of clause 13 wherein communicating the recommendation message comprises invoking a function of the social networking system that causes generating and providing a social message within a messaging facility of the social networking system that contains content of the recommendation message.

16. The method of clause 13 wherein communicating the recommendation message comprises causing display of a notification icon in a home page of the social networking system and, in response to receiving a selection of the notification icon, causing display of the recommendation message.

17. The method of clause 13 wherein communicating the recommendation message comprises causing, in association with a second account of the media viewing service that is associated with the friend represented by the particular image, display of a notification icon in an interface of the media viewing service and, in response to receiving a selection of the notification icon, causing display of the recommendation message.

18. The method of clause 13, comprising in response to receiving the selection data, communicating to a recommendations system an item of implicit positive feedback for the particular media item, and causing use of the item of implicit positive feedback in a process of recommending other media items.

19. The method of clause 13, comprising determining that a second account of the media viewing service that is associated with the particular friend represented by the first particular image has played the particular media item, and in response, generating a notification message to the account of the media viewing service associated with the recommending user indicating that the second account played the particular media item.

20. The method of clause 13 wherein the play operation comprises completing playing the particular media item.

21. The method of clause 13 wherein the particular media item is a television episode.

22. A data processing system comprising: one or more processors;

memory coupled to the one or more processors; a social recommendation unit having a social networking system interface and being coupled to the one or more processors and configured to obtain data identifying one or more friends in a social networking system; to determine an occurrence of a play operation related to a particular media item or a rating of the particular media item in association with an account of a media viewing service associated with a recommending user; to cause display of one or more images each respectively representing a friend among the one or more friends, based on the determination of the occurrence of a play operation related to the particular media item or a rating of the particular media item in association with the account of the media viewing service associated with the recommending user; to detect user input indicating movement of a cursor over a first particular image among the one or more images; and in response to detecting the user input, to automatically display, in association with the first particular image, a message indicating that the particular media item was previously viewed based on a determination that a first particular friend represented by the first particular image has previously viewed the particular media item.

23. The data processing system of clause 22 wherein the interaction with the particular media item is a rating of the particular media item.

24. The data processing system of clause 22 wherein the interaction with the particular media item is a play operation related to the media item.

25. The data processing system of clause 22 wherein the one or more processors are further configured to receive selection data indicating a single operation of a user input device in association with a second particular image among the one or more images; to automatically communicate a recommendation message identifying the particular media item to an account associated with a second friend represented by the second particular image in response to receiving the selection data.

26. The data processing system of clause 25 wherein the selection data indicates clicking or operating a pointing device while the cursor is over the second particular image.

27. The data processing system of clause 25 wherein communicating the recommendation message comprises invoking a function of the social networking system that causes generating and providing a social message within a messaging facility of the social networking system that contains content of the recommendation message.

28. The data processing system of clause 25 wherein communicating the recommendation message comprises causing display of a notification icon in a home page of the social networking system and, in response to receiving a selection of the notification icon, causing display of the recommendation message.

29. The data processing system of clause 25 wherein communicating the recommendation message comprises causing, in association with a second account of the media viewing service that is associated with the second friend, display of a notification icon in an interface of the media viewing service and, in response to receiving a selection of the notification icon, causing display of the recommendation message.

30. The data processing system of clause 22 wherein the one or more processors are further configured to receive selection data indicating a selection of a second particular image among the one or more images; in response to receiving the selection data: to automatically communicate a recommendation message identifying the particular media item to an account associated with a second friend represented by the second particular image; and to automatically communicate to a recommendations system an item of implicit positive feedback for the particular media item, and to cause use of the item of implicit positive feedback in a process of recommending other media items.

31. The data processing system of clause 25, wherein the one or more processors are further configured to determine that a second account of the media viewing service that is associated with the second friend represented by the second particular image has played the particular media item, and in response, generate a notification message to the account of the media view service associated with the recommending user indicating that the second account played the particular media item.

32. The data processing system of clause 22 wherein the play operation comprises completing playing the particular media item.

33. The data processing system of clause 22 wherein the particular media item is a television episode.

34. A data processing system comprising: one or more processors; memory coupled to the one or more processors; a social recommendation unit having a social networking system interface and being coupled to the one or more processors and configured to obtain data identifying one or more friends in a social networking system; to determine an occurrence of a play operation related to a particular media item or a rating of the particular media item in association with an account of a media viewing service associated with a recommending user; based on the determination of the occurrence of the play operation related to the particular media item or a rating of the particular media item in association with the account of the media viewing service associated with the recommending user, to cause display of one or more images each respectively representing a friend among the one or more friends; to receive selection data indicating a single operation of a user input device in association with a first particular image among the one or more images; in response to the single operation, to automatically communicating a recommendation message identifying the particular media item to an account that is associated with a particular friend represented by the first particular image.

35. The data processing system of clause 34 wherein the selection data indicates clicking or operating a pointing device while a cursor is over the first particular image.

36. The data processing system of clause 34 wherein communicating the recommendation message comprises invoking a function of the social networking system that causes generating and providing a social message within a messaging facility of the social networking system that contains content of the recommendation message.

37. The data processing system of clause 34 wherein communicating the recommendation message comprises causing display of a notification icon in a home page of the social networking system and, in response to receiving a selection of the notification icon, causing display of the recommendation message.

38. The data processing system of clause 34 wherein communicating the recommendation message comprises causing, in association with a second account of the media viewing service that is associated with the friend represented by the particular image, display of a notification icon in an interface of the media viewing service and, in response to receiving a selection of the notification icon, causing display of the recommendation message.

39. The data processing system of clause 34 wherein the one or more processors are further configured to, in response to receiving the selection data, communicate to a recommendations system an item of implicit positive feedback for the particular media item, and causing use of the item of implicit positive feedback in a process of recommending other media items.

40. The data processing system of clause 34 wherein the one or more processors are further configured to determine that a second account of the media viewing service that is associated with the particular friend represented by the first particular image has played the particular media item, and in response, generate a notification message to the account of the media viewing service associated with the recommending user indicating that the second account played the particular media item.

41. The data processing system of clause 34 wherein the play operation comprises completing playing the particular media item.

42. The data processing system of clause 34 wherein the particular media item is a television episode.

2. Description of Example Embodiments

In an embodiment, subscribers to a media viewing service are prompted to recommend already-played TV episodes or movies to their social media friends under specified conditions, can instantly see whether specified friends have already watched an item, can make instant recommendations, and receive reverse feedback when a friend watches the recommended item. The system generates and displays a post-play graphical screen that includes a recommendation region as a minority portion. Remainder region includes normal elements such as last frame of the episode; prompt to rate title with non-selected rating star icons; and box art with automatic display of a player window for the next window or recommendations for other movies.

An example media viewing service is the NETFLIX service that is commercially available from Netflix, Inc., Los Gatos, Calif. In an embodiment, the system also automatically determines if the current user is “connected on Netflix”—that is, has used Netflix to access a social networking service and authorized obtaining information for friends in the social graph who may or may not be Netflix subscribers. If the user is not connected, the system takes the user through a connection dialog to establish a connection. If the user is connected, then friends from their social graph who are also Netflix subscribers (or all social graph friends) are displayed in a row of thumbnail images.

In an embodiment, preparing to select an image of a friend for recommendation—for example, by hovering a cursor over the image, using a pointing device coupled to a computing device—causes automatically determining whether the friend has already seen the video, and if so, displaying a “SEEN IT” message over the friend image, while still permitting selection of that friend for recommendations.

One-click recommendations: In an embodiment, selecting a friend causes automatically sending a recommendation message to that friend immediately in response to the selection click, and immediately displaying confirmation of the send.

Select-and-submit recommendations: Additionally or alternatively, selecting a friend causes displaying a selection indicator (check mark) over the thumbnail image. Then, selecting a Submit icon causes sending recommendations to all those who were selected.

Notifications: In one approach, the selected friend receives a message within the social networking service (e.g., a Facebook message) that contains box art, title, and a link to instant view the item in Netflix. In another approach, the friend receives a notification within a media viewing service, such as the Netflix service, indicated by a distinct notification icon at the top of the friend's Netflix home page. Selecting the icon causes displaying box art, title, and link. In an embodiment, if a friend watches a recommended item, then a notification is provided back to the recommending member; the notification is announced using an icon in the recommending member's Netflix home page.

A recommendation by a current user to a friend, even in the absence of making an explicit rating of the media item using the star rating icons, may be used as an item of implicit positive feedback for the media item in Netflix's other recommendations systems, for the purpose of making recommendations to the current user of other media items or to the recommending user himself.

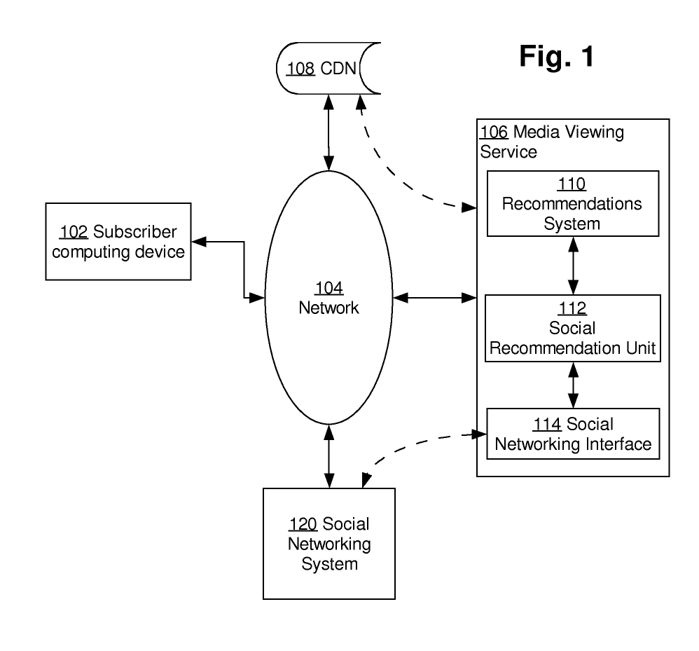

FIG. 1 illustrates a data processing system with which an embodiment may be implemented. In an embodiment, a subscriber computing device 102 is coupled to a network 104 and is communicatively coupled to a media viewing service 106 and a social networking system 120. In an embodiment, a subscriber computing device 102 comprises any computing device that is compatible with the media viewing service 106, such as a desktop computer, laptop computer, netbook, ultrabook, or mobile computing device such as a tablet computer, smartphone, or personal digital assistant. For purposes of illustrating a clear example, FIG. 1 shows a single device 102 but in practice there may be thousands or millions of such devices.

The network 104 broadly represents one or more local area networks, wide area networks, internetworks and internets, in any combination. For example, subscriber computing device 102 may couple to a wireless access point, a local internet service provider and the public internet.

The media viewing service 106 represents one or more server computers, virtual machine instances in data centers or cloud computing centers, or clusters, with stored programs that implement a system for subscribing to the service, selecting one or more media items, forming queues, viewing media items using streaming video delivery, and related functions. A commercial example of media viewing service 106 is the NETFLIX service that is commercially available from Netflix, Inc., Los Gatos, Calif., but other media viewing services, digital libraries, and like systems may be used in other embodiments. The particular configuration of the media viewing service 106 is not critical and its main attributes are the ability to select and play audiovisual media items such as TV episodes or movies from among a library of such media items.

In an embodiment, the media viewing service 106 comprises a content delivery network or CDN 108, recommendations system 110, social recommendation unit 112, and social networking interface 114. In an embodiment, the CDN 108 comprises a plurality of distributed networked storage devices and control computers that cooperate to store multiple copies of media items encoded in formats that are compatible with different types of subscriber computing devices 102 and different network bandwidth or bitrate requirements. In alternative embodiments, the use of a CDN 108 is not required and storage local to media viewing service 106 may be used for media items. Thus, CDN 108 broadly represents any form of storage of audiovisual media items that is capable of receiving requests to play a particular media item and to deliver data representing that media item through network 104 to subscriber computing device 102.

In an embodiment, the recommendations system 110 comprises computing devices and/or stored programs that are configured to communicate recommendations of media items to subscriber computing device 102, or to a user or account in the media viewing service 106 that is associated with the device. For example, recommendations systems 110 may be configured to collect or obtain data relating to preferences or tastes of a user associated with subscriber computing device 102 (or an account in the media viewing service 106 that is associated with the device), and/or about media items that a subscriber or account actually played or viewed, and to compute or determine recommendations of other media items based upon the data and other data relating to preferences, tastes, or views and plays of similar subscribers or other subscribers.

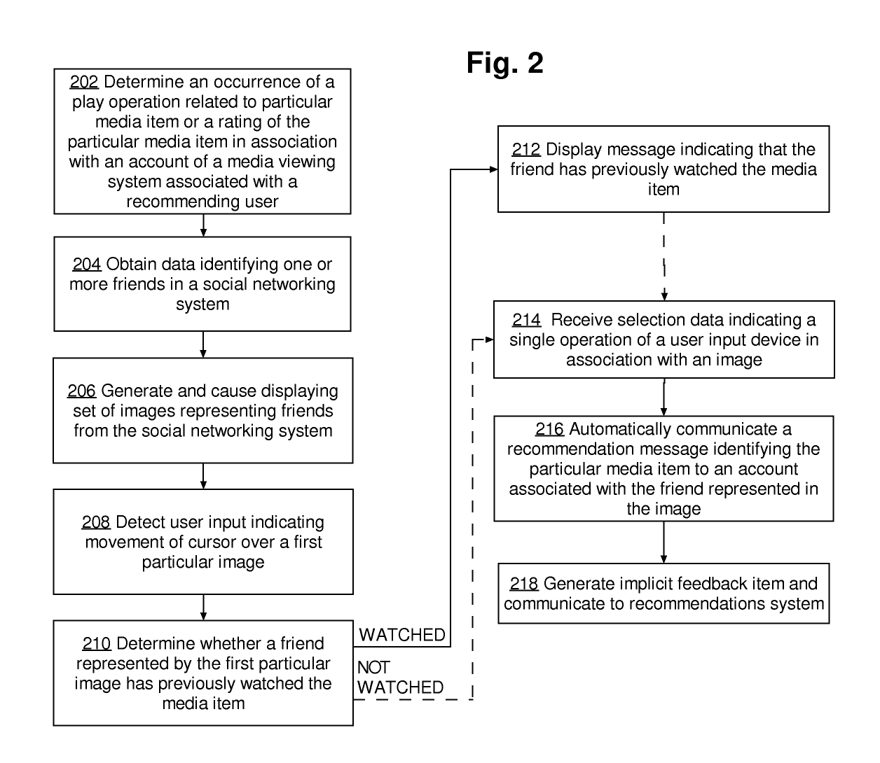

In an embodiment, the social recommendation unit 112 comprises computing devices and/or stored programs that are configured to implement the processes of FIG. 2 and other drawing figures and descriptions herein. In general, social recommendation unit 112 comprises stored programs and/or logic that are configured to provide, when executed, processes with which a subscriber to a media viewing service may recommend one or more played or viewed media items to one or more friends, may receive notifications when the friends view or play the recommended media items after receiving the recommendation, and may contribute implicit feedback to a separate recommendation system regarding a recommended media item. Subscribers also receive rapid indications, at the time that the subscribers are preparing to make recommendations of media items, about whether friends have already played or viewed the media items. In one embodiment, a recommendation may be communicated to a selected friend using a single operation of a pointing device.

In an embodiment, the social networking interface 114 comprises a set of stored programs that are configured to invoke API calls or other interface units of the social networking system 120. In other words, social networking interface 114 comprises the logic that enables the social recommendation unit 112 to communicate with the social networking system 120 to obtain social graph data stored at the social networking system, such as data about friends of a particular subscriber who is associated with subscriber computing device 102. In an embodiment, the social networking system 120 comprises a separate service that implements social networking functions and maintains a graph of metadata relating to friends of subscribers or other users. Commercial examples of social networking system 120 include FACEBOOK and GOOGLE+.

FIG. 2 illustrates an example process flow that may be executed using one or more computing devices to implement an embodiment. At block 202, the process determines an occurrence of a play operation related to a particular media item or a rating of the particular media item in association with an account of a media viewing service associated with a recommending user. For example, the media viewing service 106 may detect that subscriber computing device 102 played at least a portion of a particular TV episode or movie, completed playing the particular TV episode or movie, or rated the particular TV episode or movie while logged into the account of the media viewing service.

In response, at block 204, the process obtains data identifying one or more friends in a social networking system. The data may be obtained from a storage unit located at or accessible to media viewing service 106. Media viewing service 106 may have determined the friends of a recommending user by issuing a call to one or more social graph functions of the social networking system by using social networking interface 114 to call social networking system 120 and request friend data for a subscriber or account-holder of service 106 who viewed the TV episode or movie using device 102. The friend data may be obtained from social networking system 120 periodically prior to the occurrence of the play operation or the rating of the media item or may be obtained in response to the occurrence of the play operation or the rating of the media item.

In some embodiments, only particular types of play operations or ratings cause social recommendation unit 112 to prompt subscriber computing device 102 to recommend the particular media item to another user. For example, the subscriber computing device may only be prompted if the particular media item was rated using at least a particular value, such as five stars out of five stars. As another example, if the particular media item is an episode of a television show, the subscriber computing device may only be prompted if all of the episodes of the series or a particular season have been played by the subscriber computing device.

Additionally, the prompting may only occur for certain types of media items in some embodiments. For example, for television shows, the subscriber computing device may only be prompted if the play operation was related a first, second, or final episode of a series. In some embodiments, the prompt is not displayed for any media item that has already been recommended by the subscriber computing device.

In other embodiments, a subscriber may view an option to recommend a media item by browsing or searching for the media item rather than only viewing the option in response to a triggering event such as a rating or playing of the media item. In such an embodiment, a subscriber may recommend a media item without having played or rated the media item.

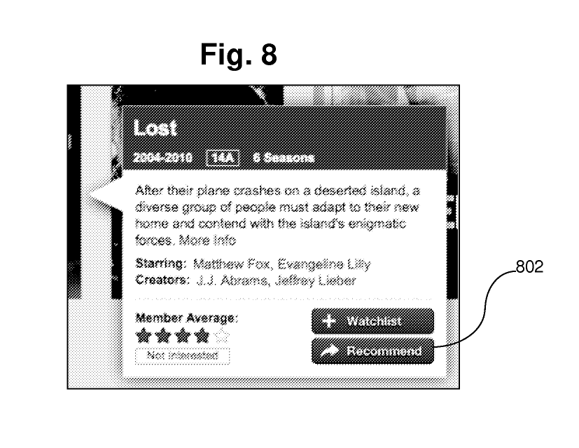

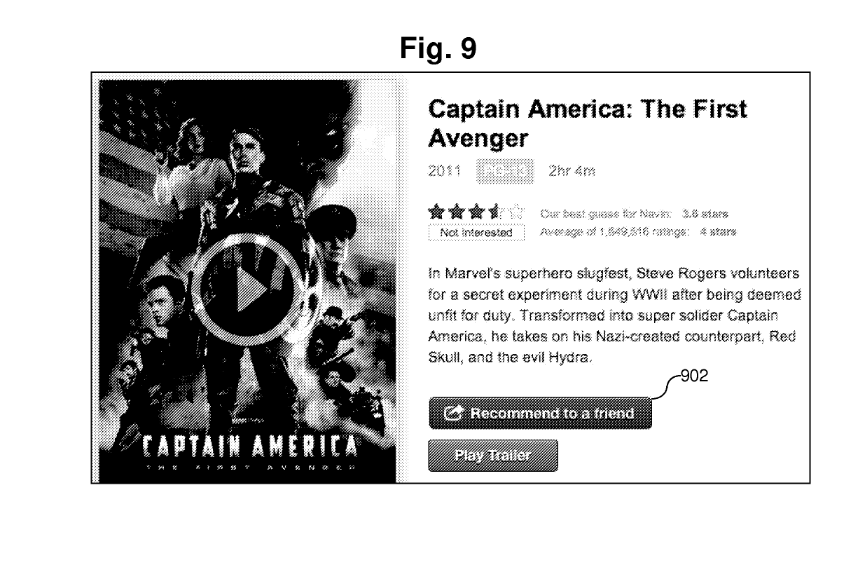

For example, FIG. 8 and FIG. 9 illustrate portions of example graphical user interfaces that may be used in one embodiment showing an example recommend link. The portion shown in FIG. 8 may be displayed when the subscriber is browsing titles to potentially view in a screen display that contains box art images for a large number of available media titles. An example is the home screen of the NETFLIX service as displayed at the time of this writing, comprising a plurality of rows of box art images, each image representing an available media item or title. In an embodiment, when the subscriber hovers a cursor over one particular box art image for a particular media item, in response, the portion of FIG. 8 is displayed. The portion of FIG. 8 includes RECOMMEND link 802 which, when selected, causes displaying a user interface panel of the format shown in FIG. 7, for example. Thereafter, the subscriber can select one or more friends of that subscriber in the social networking system and cause sending recommendations to the friends. FIG. 9 shows a similar GUI portion with a RECOMMEND TO A FRIEND link 902 which, when selected, causes displaying a user interface panel of the format shown in FIG. 7, for example. The format of FIG. 9 may be used in displays of the media viewing service 106 that are generated and displayed after the user selects a particular title and is preparing to watch the title, for example.

In block 206, the process generates and causes displaying a set of images representing friends from the social networking system. In an embodiment, thumbnail images of the subscriber's friends are displayed in a graphical user interface on subscriber computing device 102.

The set of images representing friends may be displayed in response to the occurrence of the play operation or the rating or at a later time. For example, in one embodiment the images representing the subscribers' friends are displayed in a post-play screen in response to determining that the playing of the media item has completed. In another embodiment, the images representing the subscriber's friends may be displayed at a later time, such as the first time subscriber computing device 102 returns to a homepage of media viewing service 106 after completing playing of the media item, rating the media item, or after recommending some other media item.

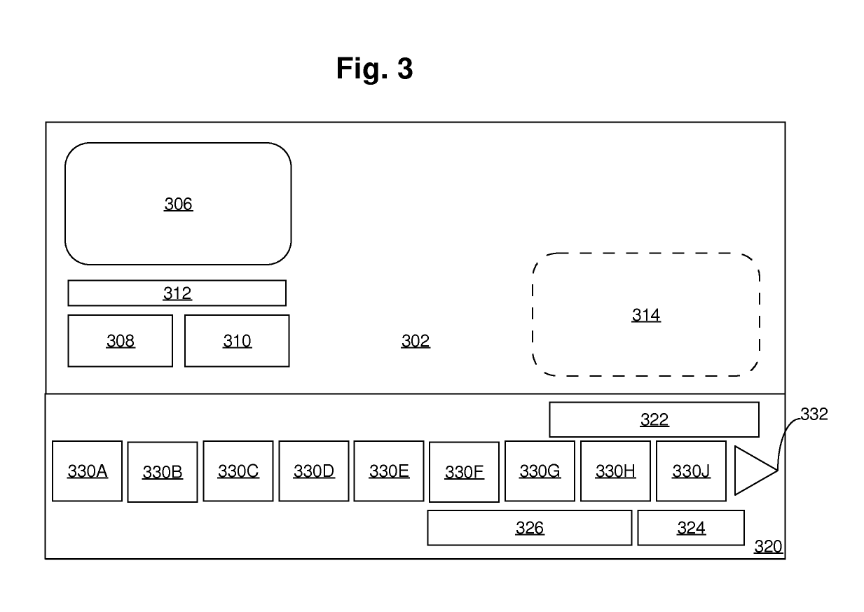

FIG. 3 illustrates in block diagram format an example graphical user interface that may be used in one embodiment. In this example, a screen display 302 is a post-play screen that comprises a title screen 306 that displays video from the media item that the subscriber just finished watching; in some embodiments, display 302 may be generated and displayed on device 102 as the end titles or other final data for a media item are playing, and in other embodiments the title screen 306 may show a freeze-frame of a final frame of the media item.

Screen display 302 may further comprise a rating prompt region 312 that may contain a message, star icons, or other graphics that prompt the subscriber to apply a personal rating to the media item that was just watched. As further described, in the process of FIG. 2, an item of implicit feedback will be generated for the media item if the subscriber recommends the media item to a friend even without entering a rating using rating prompt region 312.

Screen display 302 may further comprise graphical control buttons 308, 310 for invoking functions such as exiting the play screen, returning to a browse screen, or other functions as appropriate for the service 106. When the media item that the subscriber just watched is an episode of a television series consisting of many episodes, then in an embodiment, the screen display 302 may further comprise a next episode region 314 that identifies the next episode in the TV series. In some embodiments the region 314 may be configured to automatically start playing the next episode after a specified time period.

Screen display 302 may further comprise a social recommendations region 320 comprising a plurality of thumbnail images 330A-330J of friends of the current subscriber or user. In an embodiment, a specified number of thumbnail images are displayed, such as ten (10) images, and screen display 302 may further comprise an arrow icon 332 which when selected causes the set of thumbnail images to scroll linearly so that other friends are displayed. If the user has fewer than the specified number of friends, then the arrow icon 332 is not displayed and scrolling is not needed because images for all friends can be shown in region 320. Block 206 of FIG. 2 may comprise generating and causing a display of the form shown in FIG. 3 and particularly including a set of thumbnail images representing friends of the current subscriber.

Screen display 302 may further comprise a search box 322 that is configured to receive text input specifying the name of a friend in the social networking system and to display a thumbnail image of any matching friend among the thumbnail images 330A-330J.

Screen display 302 may further comprise a message box 326 that is configured to receive user input of a text message that the system should send with a recommendation to one or more selected friends.

In some embodiments, if the account associated with the play operation or rating has not been connected to a social networking service, a graphical interface including an invitation to connect the account to the social networking service is displayed. Once connected, images representing the friends of the connected social networking account may be displayed.

In some embodiments, the images representing the friends may only be images representing friends that have connected their social networking accounts to their media viewing service accounts. In other embodiments, images representing all friends may be displayed regardless of whether the friends have connected their social networking accounts to any media viewing service accounts.

Referring again to FIG. 2, in block 208, the process detects user input indicating movement of a cursor over a first particular image. For example, while viewing the screen display 302 of FIG. 3, a user of the subscriber computing device 102 may use a pointing device to move a cursor over thumbnail image 330A, thus pausing or hovering at least momentarily over the thumbnail image. The movement and/or position of the cursor over one of the thumbnail images may be detected using client-side code executing on the subscriber computer. For example, the media viewing service 106 may provide a client-side player application or may use browser-executed code to detect client-side interactions with the graphical user interface represented in display 302.

In block 210, the process determines whether the friend represented by the first particular image has previously watched the media item. For example, in response to detecting the user input indicating hovering or pausing over the first thumbnail image 330A, the process may determine a user identifier within the media viewing service 106 that is associated with the friend represented in the first thumbnail image and query a database of the media viewing service to determine whether that user identifier has previously viewed the media item that the current subscriber just watched. If the user for that user identifier has previously viewed the media item that the current subscriber just watched, then control transfers to block 212; if the friend has not watched the media item, then control transfers to block 214.

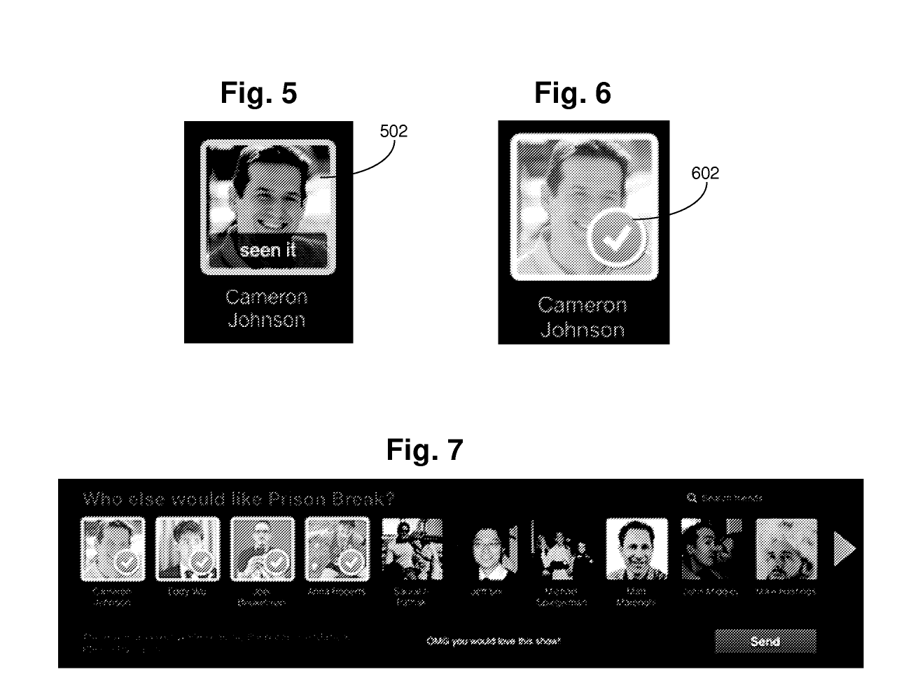

In block 212, the process displays a message indicating that the friend has previously watched the media item. For example, in one embodiment, a message such as SEEN IT or ALREADY VIEWED is displayed in superimposition over the thumbnail image 330A representing the friend. FIG. 5 illustrates a thumbnail image of a social networking friend with a message indicating that the friend has already played or viewed a media item, in one embodiment. In the example of FIG. 5, a part 502 of the graphical user interface may comprise a thumbnail image 504 of a user or subscriber, a name 506 of the user or subscriber, and a message 508 indicating that the user or subscriber has already played or viewed the media item. The message SEEN IT is used in this example, but other text could be used.

At block 214, at some point after performing block 210, 212, the process receives selection data indicating a single operation of a user input device in association with an image. Arrows with broken lines in FIG. 2 indicate that any amount of time may elapse between the operations represented in blocks that are linked using the arrows with broken lines. For example, block 214 may involve receiving an indication that the user of subscriber computing device 102 used a single click, tap or other operation with a pointing device, touchpad or touch screen to indicate selection of a particular thumbnail image 330A representing a particular friend.

At block 216, in response to block 214, the process automatically communicates a recommendation message identifying the particular media item to an account of the media viewing service that is associated with the friend who is represented in the image. For example, the process may form and store a recommendation message in association with the account of the media viewing service 106 that is associated with the friend who is represented in the particular thumbnail image 330A. Additionally or alternatively, the process may use social networking interface 114 to call functions of social networking system 120 to form and store a message in association with an account of the social networking system associated with the friend, while providing appropriate message data for the recommendation message. A visual indication such as the text SENT may be displayed in response to storing the recommendation in association with an account of the friend.

Thereafter, the friend to whom the media item was recommended may see or read the recommendation message while using that friend's account in social networking system 120 or media viewing service 106.

In some embodiments, in response to block 214, a message indicating whether the recommendation is being delivered via the social networking system or the media viewing service is displayed to the recommending user. For example, if the social network account of the friend represented by the first particular image is not connected to any media viewing service account, a symbol may be displayed in association with the first particular image indicating that the recommendation will be displayed to the friend within a graphical interface of the social networking system.

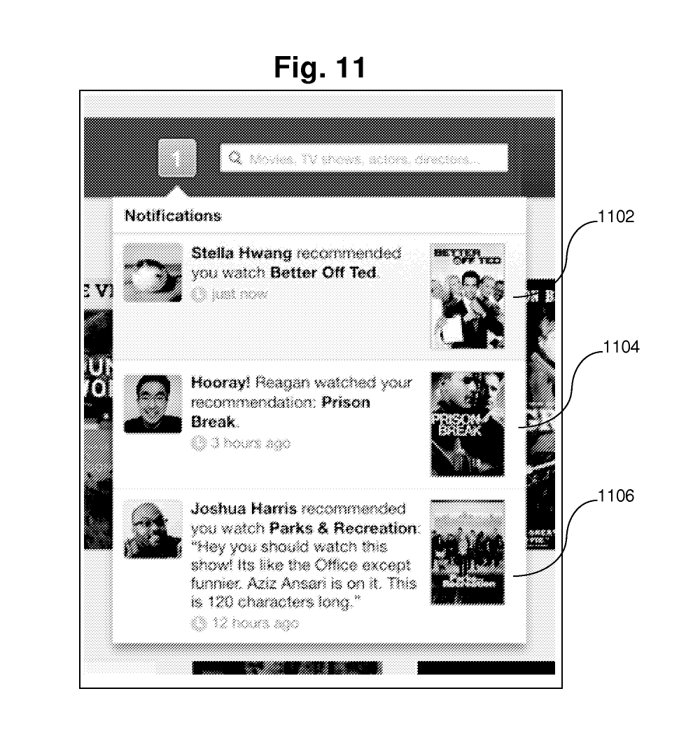

FIG. 11 illustrates a portion of an example graphical user interface that may be used in one embodiment showing a notification icon and three (3) notification messages relating to recommendations and viewed recommendations. The notification icon and notification messages may be displayed within a graphical interface displayed by social networking system 120 or a by media viewing service 106.

FIG. 11 includes a notification icon comprising the numeral “1” within a square box indicating that one (1) notification is newly received in the account with which the GUI of FIG. 11 has been displayed. In various embodiments, hovering over or selecting the notification icon results in displaying all notifications that are then currently stored in the media viewing service 106 for the current subscriber, including new notifications and previously viewed notifications.

FIG. 11 also illustrates two different types of notifications. A first notification type is represented by notification 1102 which states STELLA HWANG RECOMMENDED YOU WATCH BETTER OFF TED. This type of notification is an inbound recommendation in which another subscriber has recommended a title to the current subscriber. As illustrated by notification 1106, inbound recommendations may also include text provided by the recommender.

The second notification type is represented by notification 1104 which states HOORAY! REAGAN WATCHED YOUR RECOMMENDATION: PRISON BREAK. This type of notification is a confirmation or reverse notification informing the current subscriber that a recommendation previously made to a second subscriber resulted in the second subscriber actually watching the recommended media item. Using this approach, a first subscriber's device 102 can receive new and useful feedback information to indicate whether recommendations were acted upon; further, the first subscriber's computer acquires new and previously unavailable information indicating that the second subscriber apparently liked and wanted to watch the recommended media item.

In some embodiments, after a user views a media item that was recommended to him by another user, the user may be prompted to send a message to the recommending user. For example, notification 1104 may include a comment entered by Reagan after Reagan watched a media item that was recommended by the recommending user.

Thus, block 214, 216 collectively implement a one-click recommendation approach in which a first user of a media viewing service can recommend a media item, which the first user just watched or rated, to a second user of the media viewing service, by selecting a thumbnail graphic image representing the second user and taking no action other than the selecting. Additionally or alternatively, the process of FIG. 2 and the GUI of FIG. 3 may implement a select-and-send recommendation interface in which the first user selects one or more graphic images of one or more friends and then separately selects a SEND button, icon or other GUI widget to signal the process to send recommendation messages to the one or more friends who were selected. In some embodiments, a subscriber may include a comment in addition to the media recommendation.

At block 218, the process generates an implicit feedback item and communicates the implicit feedback item to a recommendation system. Note that block 218 is executed when the subscriber has recommended a media item to a friend. The act of recommending a media item to a friend is construed as an indication that the subscriber likes or approves of the recommended media item, even when the subscriber has not entered an explicit rating of the media item using a ratings system. Consequently, via block 218, the act of recommending a media item to a friend in a social networking system may be used to influence future recommendations of other media items to the subscriber, even when the subscriber did not indicate a specific rating of the media item, or to other subscribers. Block 218 involves communicating an implicit feedback item to any of a plurality of different recommendations systems that may be implemented in the media viewing service 106.

In some embodiments, the frequency with which a media item is recommended by users may be one of a plurality of signals used by media viewing service 106 to rank media items in the recommendation system. In another embodiment, a percentage value representing the number of times the media item is recommended out of the number of times the media item is viewed is one of a plurality of signals used by media viewing service 106 to rank the media items. For example, a first media item may be ranked higher than a second media item and consequently recommended to a user by the system before the second media item based in part on a determination that the first media item is recommended to other users a greater percentage of the times it is viewed than the second media item is. In yet another embodiment, media viewing service 106 may recommend media items to a user that are similar to a particular media based on a determination that the user recommended the particular media item to other users.

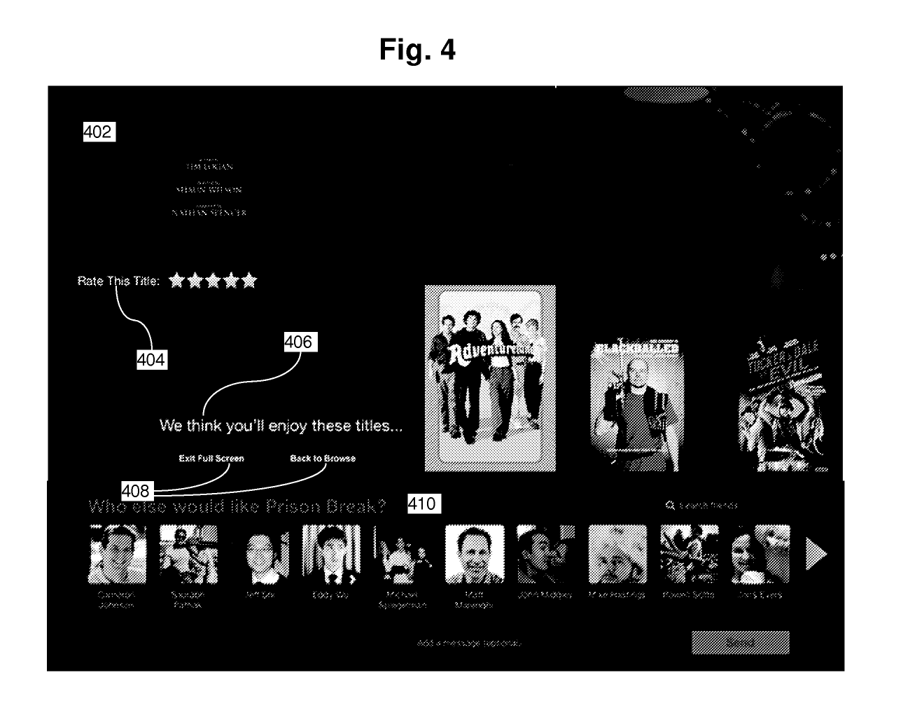

FIG. 4 illustrates an example graphical user interface that may be used in one embodiment. In the example of FIG. 4, a subscriber has just completed watching the movie PRISON BREAK and media viewing service 106 has caused displaying of a post-play screen on computing device 102 that includes credit frame 402 from PRISON BREAK, prompt 404 to RATE THIS TITLE, recommended other titles indicated by text 406 which states WE THINK YOU'LL ENJOY THESE TITLES, and control icons 408 for the functions EXIT FULL SCREEN viewing mode and BACK TO BROWSE for searching for other titles. FIG. 4 also includes social networking region 410 titled WHO ELSE WOULD LIKE PRISON BREAK? and comprising a list or row of thumbnail graphic images of the current subscriber. At the right end of the row, a triangle icon indicates that selecting the icon will cause the row to scroll to the left so that more thumbnail images of friends will appear at the right end of the row, if the subscriber has more than 10 friends in the social networking system in this example.

FIG. 6 illustrates a thumbnail image of a social networking friend with an icon indicating that the friend is selected. In the example of FIG. 6, a checkmark icon 602 is superimposed over the thumbnail image 502 of the user or subscriber, and the same general form as in FIG. 5 may be used. A checkmark icon 602 is used in this example, but other icons, marks, highlighting or color treatment, or other indications could be used in other embodiments. FIG. 7 illustrates a portion of an example graphical user interface that may be used in one embodiment showing multiple selected friends, an error message and a comment. In this example, the subscriber has clicked or tapped on the thumbnail graphic images for the first four friends shown in the left part of the row. The thumbnail images are redisplayed with a selection icon in the form of FIG. 6.

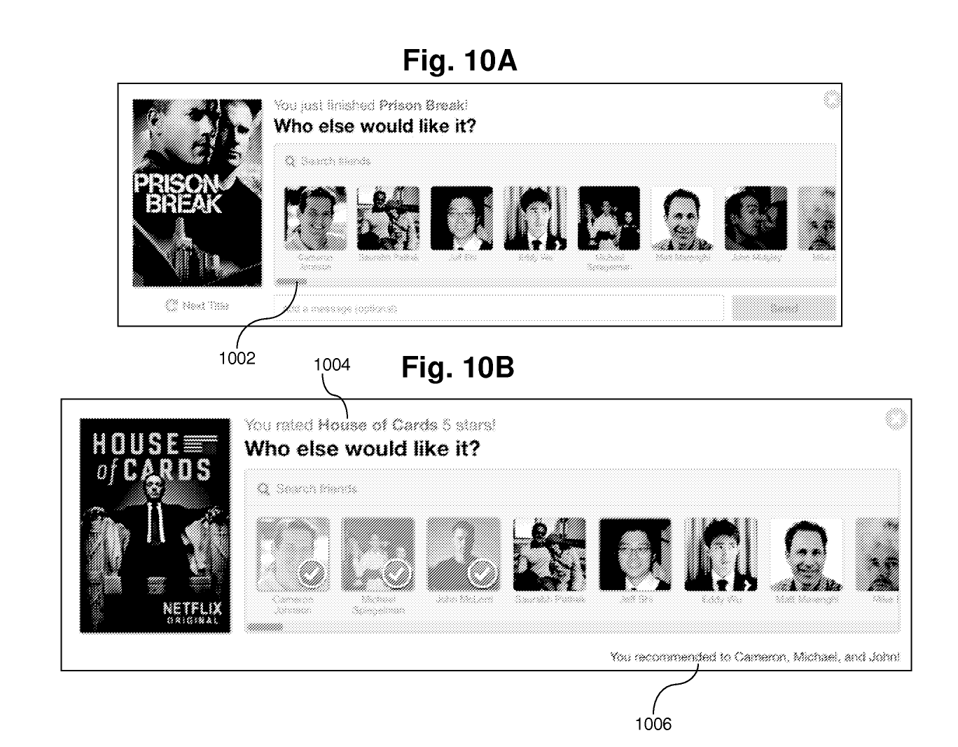

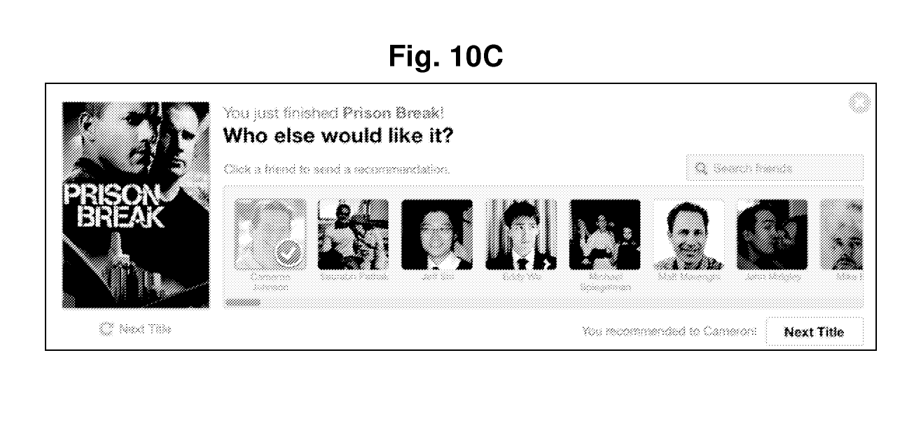

FIG. 10A illustrates a portion of an example graphical user interface that may be used in one embodiment. The GUI of FIG. 10A includes scroll bar 1002 that is displayed immediately below and adjacent to a row of thumbnail images representing friends from the social networking system and using a pointing device, touchpad or touchscreen to move the scroll bar causes the list of friends to scroll. The example graphical user interface illustrated in FIG. 10A may be displayed in response to subscriber computing device 102 completing playing of the last episode of the last series of Prison Break.

The images representing friends may be ordered in different ways according to different embodiments. In some embodiments, images of friends to which a subscriber has most frequently recommended media items, or from whom the subscriber most frequently received recommendations for media items, may appear first in the list displayed to the subscriber in order of frequency of recommendations. The remaining images may be ordered according to a friend coefficient associated with each friend. Media viewing service 106 may receive from social networking system 120 a friend coefficient for each friend indicating how frequently the subscriber and the friend interact via the social networking system. In some embodiments, the images representing friends may be ordered according to the alphabetical ordering of the friends' names.

FIG. 10B illustrates a portion of an example graphical user interface that may be used in one embodiment showing multiple selected friends and a confirmation message. Three (3) friends have been selected and the GUI of FIG. 10B may be displayed after the subscriber entered an explicit rating for the title, resulting in message 1004 which states YOU RATED HOUSE OF CARDS 5 STARS appearing in the GUI. FIG. 10B also includes message 1006 which states YOU RECOMMENDED TO CAMERON, MICHAEL AND JOHN as a confirmation of the subscriber's selection of the three (3) friends in the row of thumbnail images, indicating that the system has communicated recommendation messages to those friends, either through a notification facility in the media viewing service 106 or through messages that are generated using the social networking service 120. The message may be updated to include additional names in response to additional selections of friends by the subscriber or a number indicating the number of friends selected by the subscriber. For example, as more friends are selected, the message may be updated to state “YOU RECOMMENDED TO CAMERON, MICHAEL, JOHN AND 3 OTHERS.”

FIG. 10C illustrates a portion of an example graphical user interface that may be used in one embodiment showing a selected friend, a confirmation message and a prompt for a next title.

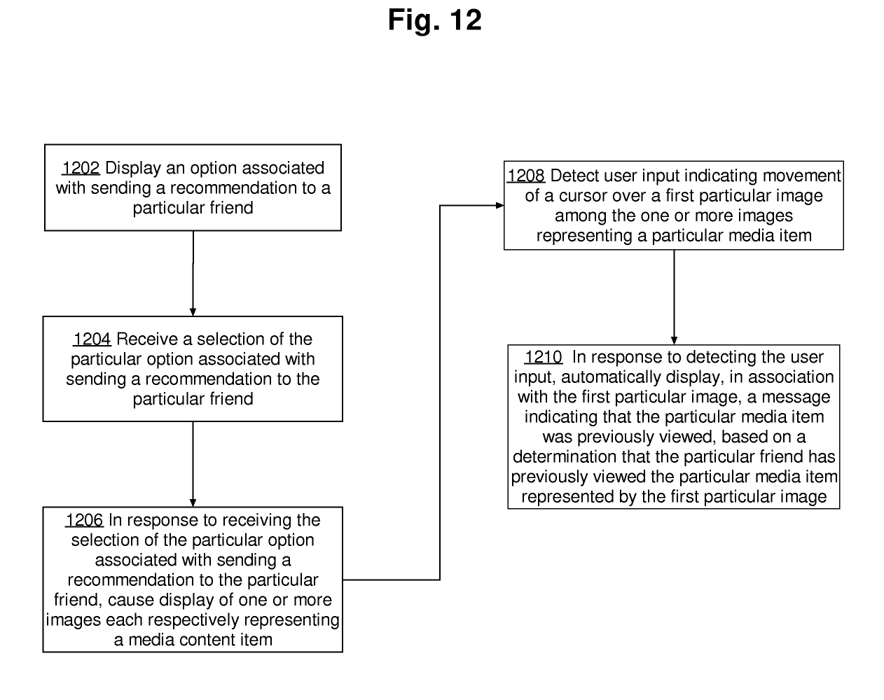

FIG. 12 illustrates another example process flow that may be executed using one or more computing devices to implement an embodiment. The process of FIG. 12 may be performed by media viewing service 106.

At block 1202, the process displays an option associated with sending a recommendation to a particular friend of a subscriber associated with subscriber computing device 102. The subscriber may be logged into a particular media viewing service account and the friend may be a friend of the subscriber on a social networking system account linked to the particular media viewing service account.

According to certain embodiments, media viewing service 106 may have selected one or more friends to whom the subscriber is prompted to send media recommendations based on determinations that the one or more particular friends have not used media viewing service 106 for at least a particular period of time or that the one or more particular friends are enrolled in a trial subscription of media viewing service 106. For example, media viewing service 106 may select all friends of the subscriber that have accounts with media viewing service 106 but have not used their accounts for over a month. In another embodiment, media viewing service 106 may prompt the subscriber to recommend media items to friends that have requested recommendations.

At block 1204, a selection of the particular option associated with sending a recommendation to the particular friend is received. At block 1206, in response to receiving the selection of the particular option associated with sending a recommendation to the particular friend, the process causes display of one or more images each respectively representing a media item. The images may represent media items that were recently watched by a subscriber of the account to whom the prompting message is displayed. In another embodiment, the images may represent media items that were rated five stars by the subscriber of the account to whom the prompting message is displayed.

At block 1208, user input indicating movement of a cursor over a first particular image among the one or more images representing a particular media item is detected. At block 1210, in response to detecting the user input, the process automatically displays, in association with the first particular image, a message indicating that the particular media item was previously viewed, based on a determination that the particular friend has previously viewed the particular media item represented by the first particular image. In another embodiment, a different message or no message may be displayed in response to a determination that the particular friend has not previously viewed the particular media item.

The process may further comprise receiving selection data indicating a selection of a particular image representing a particular media item. In response, the process automatically communicates a recommendation message identifying the particular media item to an account of the media viewing service and/or social networking system that is associated with the particular friend.

3. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

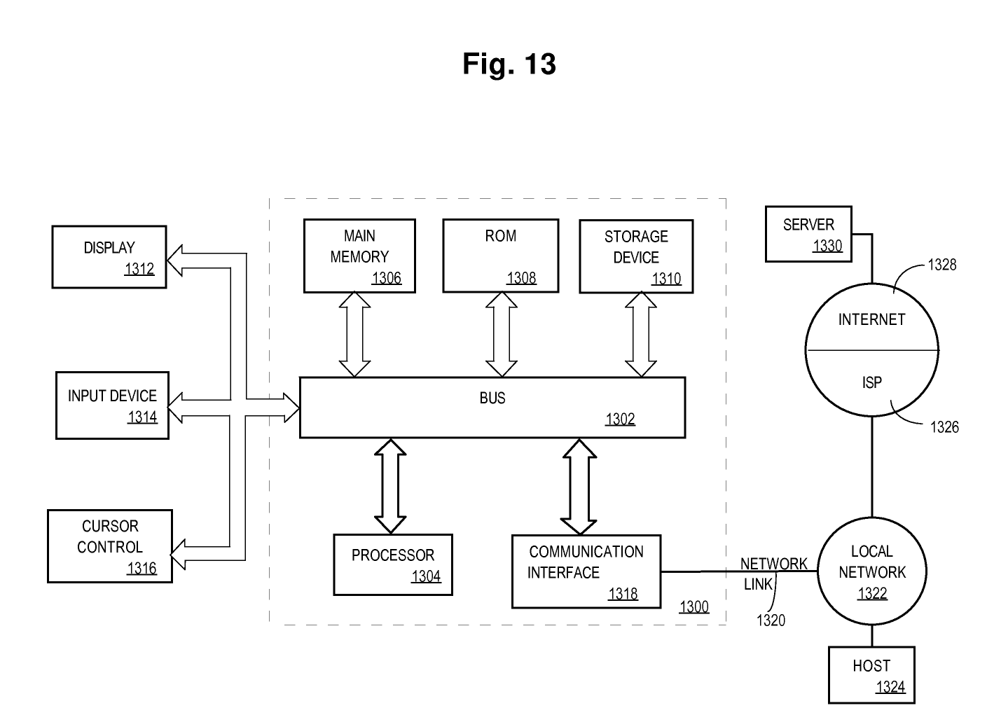

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1313, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1313. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A data processing method, comprising:
using a computer, obtaining data identifying one or more friends in a social networking system;
using the computer, determining an occurrence of an interaction with a particular media item in association with an account of a media viewing service associated with a recommending user;
using the computer, based on the determination of the occurrence of the interaction with the particular media item in association with the account of the media viewing service associated with the recommending user, causing display of one or more images each respectively representing a friend among the one or more friends;
using the computer, detecting user input indicating movement of a cursor over a first particular image among the one or more images;
using the computer, in response to detecting the user input, automatically displaying, in association with the first particular image, a message indicating that the particular media item was previously viewed based on a determination that a first particular friend represented by the first particular image has previously viewed the particular media item.

2. The method of claim 3 wherein the interaction with the particular media item is a rating of the particular media item.

3. The method of claim 3 wherein the interaction with the particular media item is a play operation related to the media item.

4. The method of claim 1, comprising:
receiving selection data indicating a single operation of a user input device in association with a second particular image among the one or more images;
in response to receiving the selection data, automatically communicating a recommendation message identifying the particular media item to an account associated with a second friend represented by the second particular image.

5. The method of claim 4 wherein the selection data indicates clicking or operating a pointing device while the cursor is over the second particular image.

6. The method of claim 4 wherein communicating the recommendation message comprises invoking a function of the social networking system that causes generating and providing a social message within a messaging facility of the social networking system that contains content of the recommendation message.

7. The method of claim 4 wherein communicating the recommendation message comprises causing display of a notification icon in a home page of the social networking system and, in response to receiving a selection of the notification icon, causing display of the recommendation message.

8. The method of claim 4 wherein communicating the recommendation message comprises causing, in association with a second account of the media viewing service that is associated with the second friend, display of a notification icon in an interface of the media viewing service and, in response to receiving a selection of the notification icon, causing display of the recommendation message.

9. The method of claim 1, comprising:
receiving selection data indicating a selection of a second particular image among the one or more images;
in response to receiving the selection data:
automatically communicating a recommendation message identifying the particular media item to an account associated with a second friend represented by the second particular image; and
automatically communicating to a recommendations system an item of implicit positive feedback for the particular media item, and causing use of the item of implicit positive feedback in a process of recommending other media items.

10. The method of claim 4, comprising determining that a second account of the media viewing service that is associated with the second friend represented by the second particular image has played the particular media item, and in response, generating a notification message to the account of the media view service associated with the recommending user indicating that the second account played the particular media item.

11. The method of claim 1 wherein the play operation comprises completing playing the particular media item.

12. The method of claim 1 wherein the particular media item is a television episode.

13. A data processing method, comprising:
using a computer, obtaining data identifying one or more friends in a social networking system;
using the computer, determining an occurrence of a play operation related to a particular media item or a rating of the particular media item in association with an account of a media viewing service associated with a recommending user;
using the computer, based on the determination of the occurrence of the play operation related to the particular media item or a rating of the particular media item in association with the account of the media viewing service associated with the recommending user, causing display of one or more images each respectively representing a friend among the one or more friends;
using the computer, receiving selection data indicating a single operation of a user input device in association with a first particular image among the one or more images;
using the computer, in response to the single operation, automatically communicating a recommendation message identifying the particular media item to an account that is associated with a particular friend represented by the first particular image.

14. The method of claim 13 wherein the selection data indicates clicking or operating a pointing device while a cursor is over the first particular image.

15. The method of claim 13 wherein communicating the recommendation message comprises invoking a function of the social networking system that causes generating and providing a social message within a messaging facility of the social networking system that contains content of the recommendation message.

16. The method of claim 13 wherein communicating the recommendation message comprises causing display of a notification icon in a home page of the social networking system and, in response to receiving a selection of the notification icon, causing display of the recommendation message.

17. The method of claim 13 wherein communicating the recommendation message comprises causing, in association with a second account of the media viewing service that is associated with the friend represented by the particular image, display of a notification icon in an interface of the media viewing service and, in response to receiving a selection of the notification icon, causing display of the recommendation message.

18. The method of claim 13, comprising:
in response to receiving the selection data, communicating to a recommendations system an item of implicit positive feedback for the particular media item, and causing use of the item of implicit positive feedback in a process of recommending other media items.

19. The method of claim 13, comprising determining that a second account of the media viewing service that is associated with the particular friend represented by the first particular image has played the particular media item, and in response, generating a notification message to the account of the media viewing service associated with the recommending user indicating that the second account played the particular media item.

20. The method of claim 13 wherein the play operation comprises completing playing the particular media item.

21. The method of claim 13 wherein the particular media item is a television episode.

22. A data processing system comprising:
one or more processors;
memory coupled to the one or more processors;
a social recommendation unit having a social networking system interface and being coupled to the one or more processors and configured to obtain data identifying one or more friends in a social networking system; to determine an occurrence of a play operation related to a particular media item or a rating of the particular media item in association with an account of a media viewing service associated with a recommending user; to cause display of one or more images each respectively representing a friend among the one or more friends, based on the determination of the occurrence of a play operation related to the particular media item or a rating of the particular media item in association with the account of the media viewing service associated with the recommending user; to detect user input indicating movement of a cursor over a first particular image among the one or more images; and in response to detecting the user input, to automatically display, in association with the first particular image, a message indicating that the particular media item was previously viewed based on a determination that a first particular friend represented by the first particular image has previously viewed the particular media item.

23. The data processing system of claim 22 wherein the interaction with the particular media item is a rating of the particular media item.

24. The data processing system of claim 22 wherein the interaction with the particular media item is a play operation related to the media item.

25. The data processing system of claim 22 wherein the one or more processors are further configured to receive selection data indicating a single operation of a user input device in association with a second particular image among the one or more images; to automatically communicate a recommendation message identifying the particular media item to an account associated with a second friend represented by the second particular image in response to receiving the selection data.

26. The data processing system of claim 25 wherein the selection data indicates clicking or operating a pointing device while the cursor is over the second particular image.

27. The data processing system of claim 25 wherein communicating the recommendation message comprises invoking a function of the social networking system that causes generating and providing a social message within a messaging facility of the social networking system that contains content of the recommendation message.

28. The data processing system of claim 25 wherein communicating the recommendation message comprises causing display of a notification icon in a home page of the social networking system and, in response to receiving a selection of the notification icon, causing display of the recommendation message.

29. The data processing system of claim 25 wherein communicating the recommendation message comprises causing, in association with a second account of the media viewing service that is associated with the second friend, display of a notification icon in an interface of the media viewing service and, in response to receiving a selection of the notification icon, causing display of the recommendation message.

30. The data processing system of claim 22 wherein the one or more processors are further configured to receive selection data indicating a selection of a second particular image among the one or more images; in response to receiving the selection data: to automatically communicate a recommendation message identifying the particular media item to an account associated with a second friend represented by the second particular image; and to automatically communicate to a recommendations system an item of implicit positive feedback for the particular media item, and to cause use of the item of implicit positive feedback in a process of recommending other media items.

31. The data processing system of claim 25, wherein the one or more processors are further configured to determine that a second account of the media viewing service that is associated with the second friend represented by the second particular image has played the particular media item, and in response, generate a notification message to the account of the media view service associated with the recommending user indicating that the second account played the particular media item.

32. The data processing system of claim 22 wherein the play operation comprises completing playing the particular media item.

33. The data processing system of claim 22 wherein the particular media item is a television episode.

34. A data processing system comprising:
one or more processors;
memory coupled to the one or more processors;
a social recommendation unit having a social networking system interface and being coupled to the one or more processors and configured to obtain data identifying one or more friends in a social networking system; to determine an occurrence of a play operation related to a particular media item or a rating of the particular media item in association with an account of a media viewing service associated with a recommending user; based on the determination of the occurrence of the play operation related to the particular media item or a rating of the particular media item in association with the account of the media viewing service associated with the recommending user, to cause display of one or more images each respectively representing a friend among the one or more friends; to receive selection data indicating a single operation of a user input device in association with a first particular image among the one or more images; in response to the single operation, to automatically communicating a recommendation message identifying the particular media item to an account that is associated with a particular friend represented by the first particular image.

35. The data processing system of claim 34 wherein the selection data indicates clicking or operating a pointing device while a cursor is over the first particular image.

36. The data processing system of claim 34 wherein communicating the recommendation message comprises invoking a function of the social networking system that causes generating and providing a social message within a messaging facility of the social networking system that contains content of the recommendation message.

37. The data processing system of claim 34 wherein communicating the recommendation message comprises causing display of a notification icon in a home page of the social networking system and, in response to receiving a selection of the notification icon, causing display of the recommendation message.

38. The data processing system of claim 34 wherein communicating the recommendation message comprises causing, in association with a second account of the media viewing service that is associated with the friend represented by the particular image, display of a notification icon in an interface of the media viewing service and, in response to receiving a selection of the notification icon, causing display of the recommendation message.

39. The data processing system of claim 34 wherein the one or more processors are further configured to, in response to receiving the selection data, communicate to a recommendations system an item of implicit positive feedback for the particular media item, and causing use of the item of implicit positive feedback in a process of recommending other media items.

40. The data processing system of claim 34 wherein the one or more processors are further configured to determine that a second account of the media viewing service that is associated with the particular friend represented by the first particular image has played the particular media item, and in response, generate a notification message to the account of the media viewing service associated with the recommending user indicating that the second account played the particular media item.

41. The data processing system of claim 34 wherein the play operation comprises completing playing the particular media item.

42. The data processing system of claim 34 wherein the particular media item is a television episode.
